(19) United States
(12) Patent Application Publication
(10) Pub. No.: US 2026/0143245 A1
(43) Pub. Date: May 21, 2026

(54) Synchronous Camera Apparatus Including A Plurality of High-Speed Cameras

(71) Applicant: nac Image Technology Inc., Tokyo (JP)

(72) Inventor: Mitsuo Hayashi, Kanagawa (JP)

(21) Appl. No.: 19/215,032

(22) Filed: May 21, 2025

(30) Foreign Application Priority Data
Nov. 18, 2024 (JP) 2024-201195

(51) Int. Cl. H04N 23/90; H04N 23/661; H04N 23/73; H04N 25/47

(52) U.S. Cl. CPC H04N 23/90; H04N 23/661; H04N 23/73; H04N 25/47

(57) ABSTRACT

A synchronous camera apparatus includes a plurality of high-speed cameras, each including synchronization signal setting means for transmitting a set synchronization signal to each of the cameras. A system control unit in each of the cameras includes trigger information setting means for setting trigger information for generating a trigger signal to a video recording unit from the received synchronization signal and camera synchronization means. The camera synchronization means includes current time generation means for synchronizing, on the basis of a current time signal transmitted from outside, the timer with the current time signal to generate a current time and determining the exposure timing on the basis of the current time, and frame association means for associating, when it is determined that the current time acquired from the current time generation means has reached the trigger information set by the trigger information setting means, which is the trigger information with the image frame.

### BACKGROUND OF THE INVENTION

### 1. Field of the Invention

The present invention relates to a synchronous camera apparatus including a plurality of digital high-speed cameras for synchronous shooting with the plurality of high-speed cameras.

### 2. Discussion of the Related Art

### Description of Configuration of General Digital High-Speed Camera

FIG. 22 illustrates a configuration of a general digital high-speed camera 1. The digital high-speed camera 1 includes a camera body 2, a photographic lens 3, and the like. Some cameras have no photographic lens 3 but use other optical systems.

The camera body 2 includes an imager unit 4 composed of, for example, an image sensor that images a target video image by sequentially performing an exposure at a set exposure timing (cycle), a video recording memory 5 composed of, for example, a DRAM formed to perform video recording in a ring buffer shape, a video recording unit 6 that sequentially video-records the video image imaged by the imager unit 4 as an image frame of digital data in the video-recording memory 5 and stops, when a predetermined number of image frames are video-recorded, the video recording in the video recording memory 5 by input of a trigger signal described below to stop overwriting, to leave respective video images as the predetermined number of image frames in the video recording memory 5, a system control unit 7 that includes, for example, a timer for managing a time, a CPU, and a RAM and a ROM including software, which are related to its operation, and performs or causes them to perform various types of calculation and storage, an image processing unit 8 composed of, for example, a DSP and a GPU, an input/output unit 9 that inputs and outputs an external signal, and a power supply unit 10 that supplies power to the camera body 2.

In FIG. 22, the imager unit 4, the video recording unit 6, the image processing unit 8, the input/output unit 9, the power supply unit 10, and the like are described as being separate from the system control unit 7. However, some or all of the imager unit 4, the video recording unit 6, the image processing unit 8, the input/output unit 9, the power supply unit 10, and the like may constitute a part of the system control unit 7.

### Description of Method for Video Recording in Video Recording Memory 5 by Video Recording Unit 6

In the conventional digital high-speed camera 1 that performs recording in a memory, the video recording memory 5 having a ring buffer shape is formed such that image frames are sequentially written from the beginning of its storage region and are sequentially written by overwriting from the beginning of the storage region immediately when written to the end thereof and the overwriting is repeated until video recording is stopped.

For example, the video recording unit 6 writes images imaged and converted into digital data by sequentially performing an exposure at a set predetermined exposure timing (cycle) in the video recording memory 5 in a ring buffer shape so that the image frames are sequentially video-recorded therein in the cycle.

The video recording unit 6 is provided with a video-recorded image frame number setting unit that previously sets the number of image frames, respective video records of which are left in the video recording memory 5 by stopping video recording to stop overwriting by trigger signal input.

The video recording unit 6 writes, from the time when a trigger signal is inputted into the video recording unit 6, a previously set predetermined number of images, and then stops the writing, to stop overwriting into the video recording memory 5 using the video-recorded image frame number setting unit. As a result, respective records of required numbers of image frames before and after the time of the trigger signal input are left in the video recording memory 5.

For example, there is a general high-speed shooting function (hereinafter referred to as normal recording) for recording the previously set predetermined numbers of written images respectively before and after the time of the trigger signal input (e.g., 100 image frames before triggering and 100 image frames after triggering (including a trigger frame at the time of the trigger signal input in this example)) as consecutive image frames in the video recording memory 5, as illustrated in FIG. 23.

The trigger frame may be included in either one of respective representations before and after triggering. Alternatively, the trigger frame may be included in neither one of the respective representations so that the trigger frame is used as a reference to separate the representations.

The video-recorded image frame number setting unit may set the previously set predetermined number of image frames before or after the time of the trigger signal input, excluding the trigger frame, to zero.

### Description of CPU Trigger Signal

A TRIG IN connector of the input/output unit 9 in the high-speed camera 1 and an electrical signal input unit, which has an appropriate input method (signal polarity, etc.) and can ignore a delay of an electrical signal, in a trigger generator that generates a trigger signal using the electrical signal input unit are directly connected to each other via an electrical signal cable without an asynchronous electronic device being interposed therebetween. There is a method for inputting the trigger signal generated by the trigger generator into the video recording unit 6 via the electrical signal cable. However, it is also possible to input a trigger (hereinafter referred to as a “CPU trigger”) generated by the system control unit 7 in the camera 1 into the video recording unit 6.

In the present disclosure, the electrical signal cable means a cable in which an asynchronous electronic device is not interposed. Examples of the electrical signal cable include a BNC (Bayonet Neill Concelman) cable and a coaxial cable.

According to a CPU trigger method, the high-speed camera 1 and a communication electronic device in the trigger generator are connected to each other in a communication format based on, for example, a TCP/IP (including UDP; the same applies hereinafter) protocol via wireless LAN (Wi-Fi) or wired LAN (Ethernet). The camera 1, which has received the trigger signal from the trigger generator, generates the CPU trigger and inputs the generated CPU trigger into the video recording unit 6. Accordingly, the CPU trigger method is used as a simple trigger signal input method.

Examples of the communication electronic device in the trigger generator include a trigger generator that generates a trigger signal using the electrical signal input unit having an appropriate input method (signal polarity, etc.) such as contact input (a contact switch) or insulation input (a current loop using a photocoupler) and capable of ignoring a delay of an electrical signal. Examples of the communication electronic device in the trigger generator include a trigger generator that generates a trigger signal using a control device such as a remote controller.

### Description of Synchronous Shooting With Cameras

When synchronous shooting is performed with a plurality of digital high-speed cameras, respective time axes of the cameras need to be accurately aligned with one another. Accordingly, for example, the cameras need to be connected to each other such that an asynchronous electronic device is interposed therebetween as little as possible. Accordingly, the cameras need to be connected to each other via an electrical signal cable represented by a BNC cable and a coaxial cable such that an asynchronous electronic device is not interposed therebetween as communication means between the cameras.

That is, the cameras are connected to each other via the electrical signal cable such that an asynchronous electronic device for communication is not interposed therebetween. For example, an asynchronous electronic device for conversion into a communication format based on a TCP/IP (also including UDP) protocol is not interposed between the cameras. This makes it possible to reduce a transmission delay caused by interposing a plurality of asynchronous electronic devices between the cameras to align the respective time axes of the cameras with each other.

The cameras respectively perform exposures at predetermined exposure timings (cycles) to match the time axes, thereby synchronizing respective image frames of the cameras with one another. The respective image frames to which a trigger signal is inputted (hereinafter referred to as trigger frames) of the cameras are made the same, thereby enabling synchronous shooting with the cameras.

Examples of a case where the respective image frames of the cameras are synchronized with one another include a case where the exposures are respectively performed at the predetermined exposure timings to match the synchronized time axes of the cameras and respective boundaries of the image frames (i.e., respective start times or end times of the image frames) set with an exposure start time or an exposure end time of the exposures used as a reference, for example, are made to match one another.

As an example of a method for making the trigger frames the same, it is determined whether or not a trigger signal has been present at an end time of each of the synchronized image frames of the high-speed cameras, as illustrated in FIG. 24. When it is detected that the trigger signal has been present, the image frame is determined to be a trigger frame at the time when the trigger signal has been present. This makes it possible to make the respective trigger frames of the cameras match one another, enabling simultaneous shooting with the plurality of cameras.

For example, a general high-speed video camera is disclosed in Japanese Patent No. 4,657,379.

### SUMMARY OF THE INVENTION

### Description of Reason Why Trigger Signal is Difficult to Simultaneously Input into Video Recording Units 6 of Cameras

In order to perform synchronous shooting with a plurality of digital high-speed cameras 1 using the above-described CPU trigger, the CPU trigger needs to be simultaneously inputted into the respective recording units 6 in the cameras 1. However, the system control unit 7 including the CPU is not synchronized with respective image frames of the cameras 1. Therefore, it cannot be ensured that the CPU trigger is inputted into the video recording units 6 in the cameras 1 at the same timing. Accordingly, respective trigger frames of the cameras 1 cannot be made to match one another.

In order to make the respective trigger frames of the plurality of cameras 1 match one another, a trigger signal needs to be simultaneously inputted into the cameras 1 from outside. However, when each of the cameras 1 and the trigger generator are connected to each other using a communication format based on a TCP/IP protocol via, for example, wireless LAN (Wi-Fi) or wired LAN (Ethernet), it is not ensured that the respective recording units 6 in the cameras 1 simultaneously receive a signal.

In the above-described case, a plurality of asynchronous electronic devices for conversion into a communication format based on, for example, a TCP/IP (also including UDP) protocol for communication are interposed between each of the cameras 1 and the trigger generator. Accordingly, a delay cannot be ignored. Therefore, the cameras 1 are difficult to synchronize with one another.

### Description of Method for Simultaneously Inputting Trigger Signal into Video Recording Units 6 in Cameras

Accordingly, in order for the cameras 1 to simultaneously receive a signal, an electrical signal cable such as a BNC cable or a coaxial cable must be wired between each of the cameras 1 and the trigger generator such that an electronic device or the like for conversion into, for example, a communication format based on a TCP/IP protocol for communication is interposed therebetween as little as possible.

In order to synchronize the respective time axes of the plurality of cameras 1 with one another, as described above, the cameras 1 need to be connected to one another using a synchronization signal. Accordingly, an electrical signal cable for time axis synchronization needs to be wired between the cameras 1.

### Description of Disadvantages in Case of Connection via Cable

Accordingly, for example, each of cameras 1 and a trigger generator 11, which generates a trigger signal using the electrical signal input unit, need to be connected to each other via an electrical signal cable 12 for a trigger signal, and each of the cameras 1 and a time signal transmission device 13 need to be connected to each other via an electrical signal cable 14 for a time synchronization signal, as illustrated in FIG. 25. This results in a complicated cable wiring.

When a physical wiring such as a cable is used for a connection between cameras 1 or a connection between each of the cameras 1 and a synchronization system, an installation location and a movement range of the camera 1 are restricted, thereby narrowing an operable application of the camera 1.

The present invention is directed to eliminating the above-described disadvantages.

A synchronous camera apparatus including a plurality of high-speed cameras according to the present invention includes a plurality of high-speed cameras each including an imager unit that images a target video image by sequentially performing an exposure at a set exposure timing, a video recording memory, a video recording unit that video-records a predetermined image imaged by the imager unit as an image frame of digital data in the video recording memory by input of a trigger signal, and a system control unit that has a timer and performs various types of calculations, and synchronization signal setting means for setting a synchronization signal and transmitting the set synchronization signal to each of the high-speed cameras, in which the system control unit in each of the high-speed cameras includes trigger information setting means for setting trigger information for generating a trigger signal to the video recording unit from the received synchronization signal and camera synchronization means, and the camera synchronization means includes current time generation means for synchronizing, on the basis of a current time signal transmitted at a regular timing from outside, the timer with the current time signal to generate a current time and determining the exposure timing on the basis of the current time and frame association means for associating, when it is determined that the current time acquired from the current time generation means has reached the trigger information set by the trigger information setting means, the trigger information with the image frame in the case.

The synchronization signal setting means for setting the synchronization signal and transmitting the set synchronization signal to each of the high-speed cameras is event time setting means for setting an event time and transmitting the set event time to each of the high-speed cameras, the trigger information setting means for setting trigger information for generating a trigger signal to the video recording unit from the received synchronization signal is trigger time setting means for setting a trigger time for generating a trigger signal to the video recording unit from the received event time, the camera synchronization means is trigger frame synchronization means, and the frame association means for associating, when it is determined that the current time acquired from the current time generation means has reached the trigger information set by the trigger information setting means, the trigger information with the image frame in the case is means for associating, when it is determined that the current time acquired from the current time generation means has reached the trigger time received by the trigger time setting means, the trigger time with the image frame in the case.

The frame association means in each of the high-speed cameras is means for determining whether or not the current time of the image frame has reached the trigger time, setting, when it is determined that the current time has reached the trigger time, the image frame as an image frame at the trigger time, transmitting the trigger signal to the video recording unit and setting a predetermined image frame based on the image frame, and making the respective predetermined image frames match one another in the high-speed cameras, thereby synchronizing the high-speed cameras with one another.

Making the respective predetermined image frames based on the image frames match one another in the high-speed cameras, to synchronize the high-speed cameras with one another means making the respective image frames at the trigger times of the high-speed cameras match one another as predetermined image frames.

Making the respective predetermined image frames based on the image frames match one another in the high-speed cameras, to synchronize the high-speed cameras with one another means providing the frame association means in each of the high-speed cameras with an image frame setting unit that sets an image frame having a predetermined relationship with the image frame at the trigger time of the high-speed camera, to make the predetermined image frames respectively set by the image frame setting units in the high-speed cameras match one another.

The predetermined image frame is an event frame as an image frame at a time when an event time is inputted into each of the high-speed cameras.

The trigger time is set to a time later than a time when the trigger time setting means receives an event time.

The trigger time is set to a time of an image frame at a time when video recording is finished.

The trigger time is set to a time of an image frame at a time when video recording is finished, and an image frame setting unit provided in the frame association means in each of the high-speed cameras calculates an event frame as an image frame at a time when an event time is inputted from an image frame at the trigger time, and makes the respective event frames match one another in the high-speed cameras, thereby synchronizing the high-speed cameras with one another.

The trigger times respectively inputted into the high-speed cameras match one another.

The trigger time of each of the high-speed cameras is set to correspond to an exposure timing set for the high-speed camera or/and a number of image frames, respective video records of which are left in a video recording memory.

The trigger time is set to a time later than a start time and earlier than an end time of the image frame, in which the trigger time is set, of each of the high-speed cameras.

In the high-speed cameras, respective set video recording speeds of which differ from one another and respective image frames of which are synchronized with one another by making start times of the image frames match one another, the trigger time is further set to be a time obtained by adding a time period longer than zero and shorter than a cycle (one divided by the video recording speed) of the high-speed camera having the highest video recording speed to the start time of the image frame of the high-speed camera having the lowest video recording speed in which the trigger time is set.

In the high-speed cameras, respective set video recording speeds of which differ from one another and respective image frames of which are synchronized with one another by making end times of the image frames match one another, the trigger time is further set to be a time obtained by subtracting a time period longer than zero and shorter than a cycle (one divided by the video recording speed) of the high-speed camera having the highest video recording speed from the end time of the image frame of the high-speed camera having the lowest video recording speed in which the trigger time is set.

The current time signals are respectively acquired from wireless time synchronization devices respectively connected to the high-speed cameras via electrical signal cables without electronic devices being interposed thereamong and configured to be wirelessly synchronized with one another.

The synchronous camera apparatus further includes means for transmitting the event time received by at least one of the plurality of high-speed cameras to a device that transmits the event time to the other high-speed cameras.

The synchronous camera apparatus further includes means for transmitting the event time received by at least one of the plurality of high-speed cameras to the other high-speed cameras by wire or wirelessly.

The event time setting means is provided in a device separate from the high-speed cameras and transmits the event time generated by the event time setting means to each of the high-speed cameras by wire or wirelessly.

The event time setting means is provided in at least one of the plurality of high-speed cameras, and the event time generated by the event time setting means is notified to the at least one high-speed camera and is transmitted to the other high-speed cameras.

The event time generated by the event time setting means is generated on the basis of a trigger generation signal inputted into the at least one high-speed camera.

The system control unit in each of the high-speed cameras includes a sequence number setting unit that sequentially numbers an image frame recorded in the video recording memory in order at a set predetermined exposure timing, the synchronization signal setting means for setting the synchronization signal and transmitting the set synchronization signal to each of the high-speed cameras includes sequence number matching time setting means for setting (generating) a sequence number matching time for setting a sequence number of each of the high-speed cameras to a predetermined number and transmitting the sequence number matching time to each of the required high-speed cameras, and event time sequence number information setting means for setting event time sequence number information and transmitting the set event time sequence number information to each of the high-speed cameras, the trigger information setting means for setting the trigger information for generating the trigger signal to the video recording unit from the received synchronization signal includes means for making respective sequence numbers of the high-speed cameras match one another from the received sequence number matching times, and trigger sequence number setting means for setting a trigger sequence number for generating the trigger signal to the video recording unit from the received event time sequence number information, the camera synchronization means is sequence number synchronization means, and the frame association means for associating, when it is determined that the current time acquired from the current time generation means has reached the trigger information set by the trigger information setting means, the trigger information with the image frame in the case is frame association means for setting, when it is determined that the current time generated by the current time generation means has reached the received sequence number matching time, the sequence number of each of the high-speed cameras to a predetermined value using a sequence number matching unit to make the sequence numbers of the high-speed cameras match one another, and associating, when it is determined that the sequence number of each of the high-speed cameras has reached the trigger sequence number, the trigger sequence number with the image frame in the case.

The frame association means in each of the high-speed cameras is means for determining whether or not the current time generated by the current time generation means has reached the received sequence number matching time, setting, when it is determined that the current time has reached the sequence number matching time, the sequence number of each of the high-speed cameras to a predetermined value using the sequence number matching unit to make the sequence numbers of the high-speed cameras match one another, setting, when the sequence number of each of the high-speed cameras reaches the trigger sequence number, the image frame in the case as an image frame in the trigger sequence number, transmitting the trigger signal to the video recording unit, and making the image frames in the trigger sequence numbers of the high-speed cameras match one another, thereby synchronizing the high-speed cameras with one another.

When the respective exposure timings of the high-speed cameras differ from one another, the high-speed cameras are respectively provided with sequence number correction units that correct the sequence numbers of the high-speed cameras to be the same at the same time.

According to the present invention, even if respective input timings of an external signal into cameras differ from one another, event time information such as the same event time and the same event sequence number are transmitted to each of the cameras, and the cameras set the same trigger time and trigger sequence number on the basis of the event time information, thereby making it possible to make respective trigger frames of the cameras match one another. This eliminates the need for a cable wiring of a trigger signal or the like to each of the cameras.

When time synchronization of a plurality of cameras is unwired in combination with a conventional general-purpose wireless time synchronization device, a combination of a CPU trigger or the like based on time information and the wireless time synchronization device can completely eliminate a physical wiring such as a connection among the plurality of cameras and a connection between each of the cameras and a synchronization system. Therefore, it is possible to freely move the cameras.

### BRIEF DESCRIPTIONS OF THE DRAWINGS

FIG. 1 is an explanatory configuration diagram of a synchronous camera apparatus including a plurality of high-speed cameras according to the present invention;

FIG. 2 is an explanatory diagram illustrating high-speed shooting for generating a 1 Hz signal from a time signal and equally dividing the 1 Hz signal by a phase locked loop in the present invention;

FIG. 3 is an explanatory configuration diagram of high-speed cameras according to the present invention;

FIG. 4 is an explanatory diagram of time synchronization of high-speed cameras according to the present invention;

FIG. 5 is an explanatory diagram of a method for connecting event time setting means to high-speed cameras according to the present invention;

FIG. 6 is an explanatory diagram of another method for connecting event time setting means to high-speed cameras according to the present invention;

FIG. 7 is an explanatory diagram of still another method for connecting event time setting means to high-speed cameras according to the present invention;

FIG. 8 is an explanatory diagram of a further method for connecting event time setting means to high-speed cameras according to the present invention;

FIG. 9 is an explanatory diagram of a trigger time setting method according to the present invention;

FIG. 10 is an explanatory diagram of a trigger time setting method 1 according to the present invention;

FIG. 11 is an explanatory diagram of a trigger time setting method 2 according to the present invention;

FIG. 12 is an explanatory diagram of another example of the trigger time setting method 2 according to the present invention;

FIG. 13 is an explanatory diagram of a trigger time setting method 3 according to the present invention;

FIG. 14 is an explanatory diagram of another example of the trigger time setting method 3 according to the present invention;

FIG. 15 is an explanatory diagram of another example of the trigger time setting method according to the present invention;

FIG. 16 is an explanatory diagram of still another example of the trigger time setting method according to the present invention;

FIG. 17 is a diagram illustrating a comparison between respective flows of a conventional method and a new method according to the present invention;

FIG. 18 is an explanatory diagram of a method for synchronization using sequence numbers according to a second embodiment of the present invention;

FIG. 19 is an explanatory diagram of a method for synchronization using sequence numbers according to the second embodiment of the present invention;

FIG. 20 is an explanatory diagram of a method for synchronization using sequence numbers according to the second embodiment of the present invention;

FIG. 21 is an explanatory diagram of a method for synchronization using sequence numbers according to the second embodiment of the present invention;

Fig. 22 is an explanatory configuration diagram of a conventional high-speed camera;

FIG. 23 is an explanatory diagram illustrating video recording of 100 image frames before trigging and 100 image frames after triggering (including a trigger frame) by trigger input;

FIG. 24 is an explanatory diagram illustrating matching of respective image frames in which a camera 1 and a camera 2 are synchronized with each other by trigger input; and

FIG. 25 is an explanatory configuration diagram of a conventional high-speed camera.

### DESCRIPTION OF THE PREFERRED EMBODIMENTS

Preferred embodiments of a high-speed camera according to the present invention will be described below with reference to the drawings. The high-speed camera according to the present invention is not limited to those in the following description, but can be appropriately changed without departing from the spirit and scope of the present invention.

The respective meanings of “simultaneous” and “synchronous” used in the following are not strictly “simultaneous” and “synchronous”. That is, the respective meanings of “simultaneous” and “synchronous” are each a concept including an error within a range that meets the spirit and scope of the present invention and does not interfere with synchronization of image frames.

The same units as those described in the conventional example are respectively denoted by the same reference numerals. Further, descriptions thereof are omitted.

### FIRST EMBODIMENT

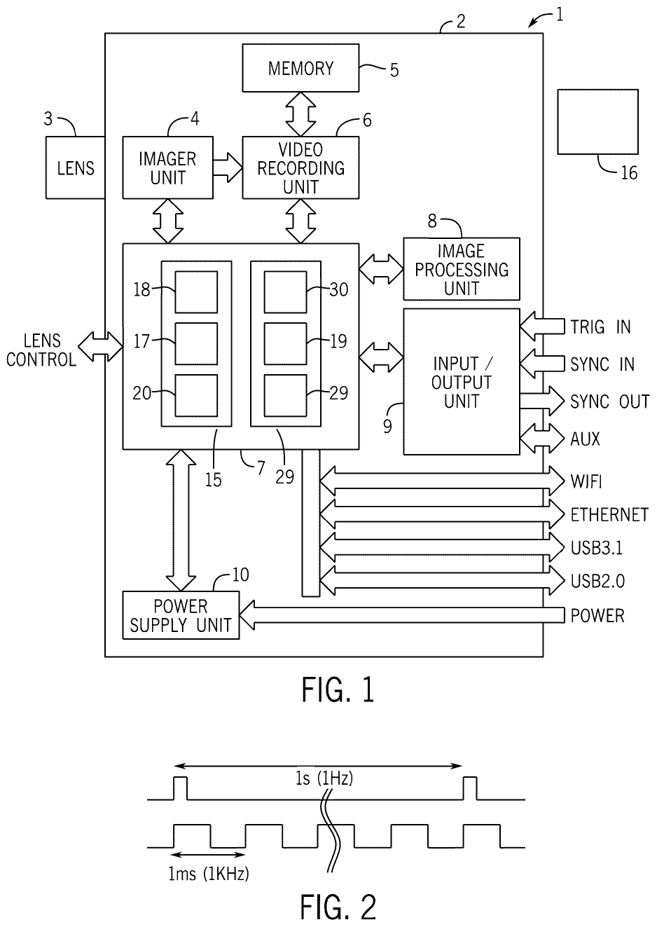

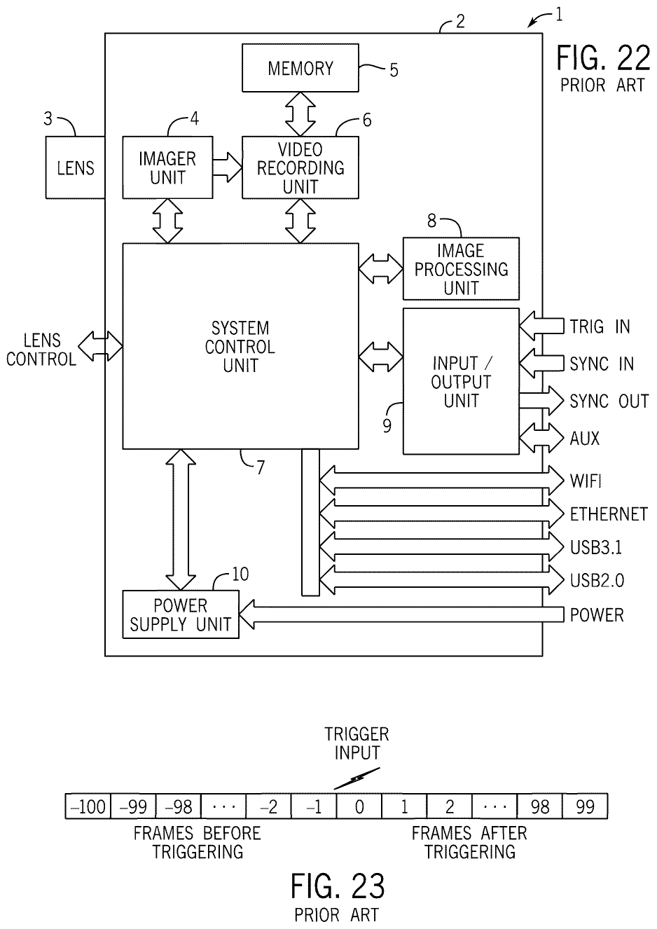

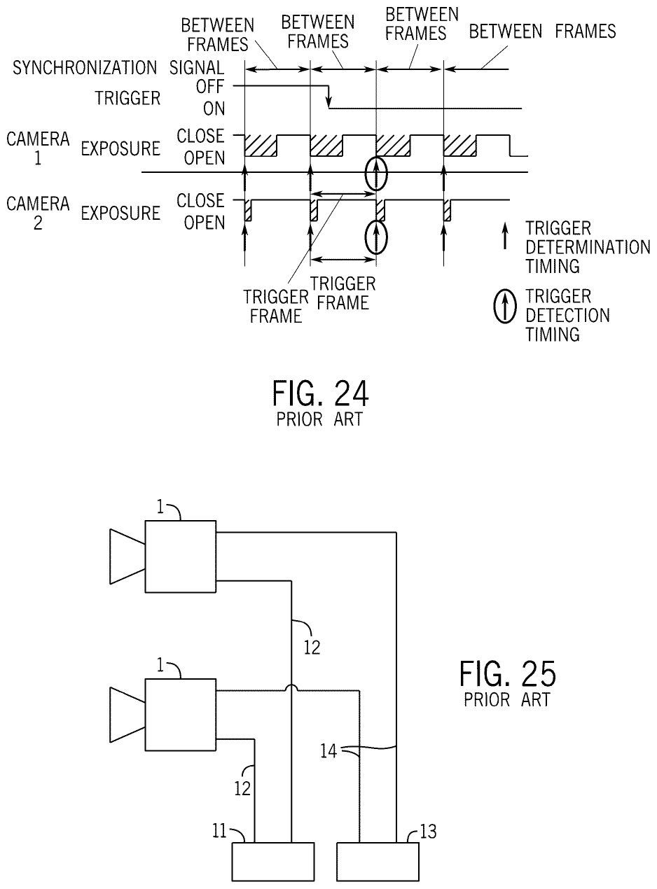

FIG. 1 illustrates a configuration of a synchronous camera apparatus according to an embodiment of the present invention. The camera contains all of the components of the camera described above and illustrated in FIG. 22.

### Description of Overall Configuration of Invention

FIG. 1 illustrates one of a plurality of high-speed cameras 1 which may, like the camera discussed above in conjunction with FIG. 22, include camera body 2 that includes an imager unit 4, a video recording memory 5, a video recording unit 6, a system control unit 7 that includes, for example, a timer for managing a time, a CPU, and a RAM and a ROM including software, which are related to its operation, and performs or causes them to perform various types of calculation and storage, an image processing unit 8 composed of, for example, a DSP and a GPU, an input/output unit 9, and a power supply unit 10. In the synchronous camera apparatus according to the present invention, trigger information setting means for setting trigger information for generating a trigger signal in the video recording unit 6, and camera synchronization means are provided in the system control unit 7 in each of high-speed cameras 1, and synchronization signal setting means for setting (generating) a synchronization signal and transmitting the synchronization signal to each of the required high-speed cameras 1 is provided in a separate device such as a tablet different from each of the high-speed cameras 1. (The term “means”, as used to discuss componentry of the camera 1 or another electronic device, should be understood to include wired circuitry and/or programmed software residing in RAM, ROM, or another processor component, or a combination thereof. For example, in the case of componentry of the control unit 7, the “means” should be understood to include any or a combination of the timer, the CPU, the RAM, and the ROM, and software).

The synchronization signal setting means may be provided in one camera 1 (parent camera 1a).

There may be provided a plurality of cameras 1 (parent cameras 1a).

In the first embodiment of the present invention, trigger information for generating a trigger signal to the video recording unit 6 is set as a trigger time, as illustrated in FIG. 1. The trigger information setting means is composed of trigger time setting means 29. The camera synchronization means is composed of trigger frame synchronization means 15.

The synchronization signal setting means for setting (generating) the synchronization signal and transmitting the synchronization signal to each of the required high-speed cameras 1 is composed of event time setting means 16 for setting (generating) an event time for setting the trigger time in the trigger time setting means 29, and transmitting the event time to each of the required high-speed cameras 1.

That is, in the first embodiment of the present invention, respective current times of timers of the high-speed cameras 1 are first synchronized with one another, and respective time axes of the cameras 1 are aligned with one another. The cameras 1 respectively perform exposures at predetermined timings (cycles) to match the time axes thereof, thereby synchronizing respective image frames of the cameras 1 with one another. The event time setting means 16 transmits the same event time to the cameras 1. The trigger time setting means 29 in each of the cameras 1 sets a trigger time from the received event time. Each of the cameras 1 transmits, when a current time of the camera 1 reaches the trigger time, a trigger signal to the video recording unit 6. As a result, respective predetermined image frames of the cameras 1 match one another, so that the cameras 1 are synchronized with one another.

The trigger time setting means 29 includes event time reception means 19 that receives the event time and trigger time generation means 30 that sets (generates) a trigger time on the basis of the event time.

The trigger time setting means 29 generates the trigger time under predetermined conditions, described below, on the basis of the event time.

The trigger frame synchronization means 15 includes current time generation means 17 for synchronizing a timer of the system control unit 7 with a highly accurate current time signal (time code) transmitted at a regular low-resolution timing from outside a time signal transmission device 13, for example, other than each of the high-speed cameras 1 and further dividing a predetermined time period at equal intervals on the basis of the current time signal, to generate a high-resolution current time, exposure signal generation means 18 for generating an exposure signal for imaging an image according to an exposure timing (cycle) set on the basis of the current time obtained by the division at equal intervals by the current time generation means 17, and frame association means 20 for associating the trigger time generated by the trigger time setting means 29 with a predetermined image frame imaged and video-recorded under an exposure by the exposure signal generation means 18.

The frame association means 20 determines whether or not the current time generated by the current time generation means 17 has reached the trigger time generated in the trigger time setting means 29, sets, when it is determined that the current time has reached the trigger time, an image frame in the case as an image frame at the trigger time, transmits the trigger signal to the video recording unit 6 and sets a predetermined image frame based on the image frame at the trigger time, and makes the predetermined image frames match one another in the cameras 1, thereby synchronizing the cameras 1 with one another.

Examples of the image frame at the trigger time include an image frame at the trigger time of each of the cameras 1. The cameras 1 may be synchronized with one another by making the respective image frames match one another.

Examples of the image frame at the trigger time include an image frame at a time slightly later than the received event time. Examples of the image frame at the trigger time include an image frame, at a final video recording time at which video recording is finished, which is set on the basis of the event time.

Examples of the predetermined image frame based on the image frame at the trigger time include a predetermined image frame, which is set by providing the frame association means 20 in each of the cameras 1 with an image frame setting unit that sets an image frame having a predetermined relationship from the set image frame at the trigger time (e.g., an event frame at an event time when the image frame at the trigger time is an image frame at the time of final video recording), (e.g., the event frame in the above-described example). The cameras 1 may be synchronized with one another by making the respective image frames match one another.

### Description of Current Time Generation Means 17

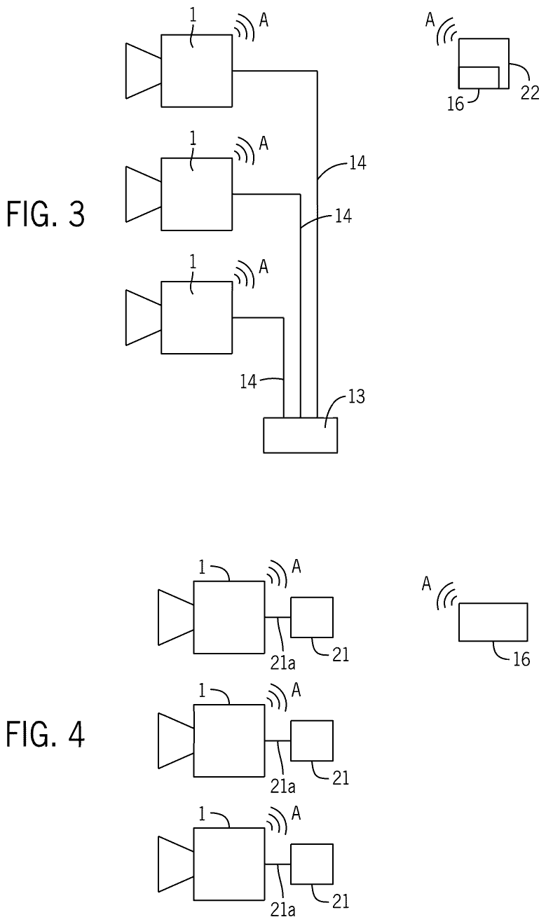

That is, for example, the time signal transmission device 13 that transmits a time signal (time code) and each of the cameras 1 are connected to each other via an electrical signal cable 14 represented by, for example, a BNC and a coaxial cable such that an electronic device is interposed therebetween as little as possible in communication means in order to reduce a transmission delay, as illustrated in FIG. 3. The system control unit 7 in each of the cameras 1 regularly receives a time signal, which has a low resolution but is highly accurate, from the time signal transmission device 13 via the electrical signal cable 14.

For example, the one camera 1 (parent camera 1a) and the time signal transmission device 13 may be connected to each other via the electrical signal cable 14 such that no electronic device is interposed therebetween. The time signal transmission device 13 may be connected to each of the other cameras 1 (child cameras 1b) by distributing the electrical signal cable 14 using a signal distributor.

Each of the cameras 1 is synchronized with the time signal, and the current time generation means 17 generates a current time. As a result, each of the cameras 1 is synchronized with the current time.

The current time generation means 17 sets a time period between timings (e.g., one second) during which a time signal is regularly received. For example, a phase locked loop (PLL), for example, provided in the current time generation means 17 equally divides (e.g., divides into 1000 equal parts) the time period between the timings (e.g., one second), as illustrated in FIG. 2. This makes it possible to generate a high-resolution and highly accurate time.

Examples of a general standard of a time code for synchronizing a plurality of devices with one another include an IRIG-B and an LTC. The time code does not have a frame rate that satisfies high-speed shooting. On the other hand, a phase shift tends to be small. Therefore, a synchronization accuracy among the devices tends to be high.

For example, in addition to connecting each of the cameras 1 and the time signal transmission device 13 to each other directly via the electrical signal cable 14, as illustrated in FIG. 3, a wireless time synchronization device 21 is connected to each of the cameras 1 via an electrical signal cable 21a represented by, for example, a BNC and a coaxial cable such that an electronic device is interposed therebetween as little as possible in order to reduce a transmission delay in communication means, as illustrated in FIG. 4. The wireless time synchronization devices 21 are wirelessly synchronized with one another. A time signal (time code) is transmitted from each of the wireless time synchronization devices 21 that are wirelessly synchronized with one another to the corresponding camera 1. Thus, the cameras 1 may be synchronized with one another.

### Description of Exposure Signal Generation Means 18

Then, the exposure signal generation means 18 generates an exposure signal at an exposure timing at the equal intervals (e.g., intervals of one millisecond) based on the current time. Images are sequentially shot by the exposure signal so that high-speed shooting is implemented.

A timing (cycle) of the exposure signal is set to a predetermined time period. If one second is divided into 1000 equal parts, for example, the timing is set to intervals of one millisecond. When the exposure signal is generated at the intervals of one millisecond, an imager unit 4 performs imaging by an exposure so that each of image frames in the cycle is generated. An exposure time period may be set shorter than the cycle in addition to being set to a time period that is considered to be the same as the cycle.

When each of the cameras 1 performs an exposure at a predetermined exposure timing (cycle) to match the current time, the respective image frames of the cameras 1 are synchronized with one another.

Examples of a case where the respective image frames of the cameras 1 are synchronized with one another include a case where exposures are respectively performed at the predetermined exposure timings to match the synchronized time axes of the cameras 1 and respective boundaries of the image frames (i.e., start times or end times of the image frames) set with an exposure start time or an exposure end time of the exposures used as a reference are made to match one another.

### Description of Event Time Setting Means 16

The event time setting means 16 is provided in, for example, a device separate from each of the high-speed cameras 1. Alternatively, the event time setting means 16 is provided in, for example, one or a plurality of high-speed cameras 1.

The event time setting means 16 includes, for example, a timer, a trigger generation signal input unit, and event time generation means for generating an event time.

Examples of the event time to be generated by the event time generation means include the time when a trigger generation signal is inputted into the event time setting means 16. Examples of the event time to be generated by the event time generation means include a predetermined time set on the basis of the time when the trigger generation signal is inputted.

The trigger generation signal input unit receives, from a trigger generator that generates a trigger generation signal, the trigger generation signal.

The trigger generator generates the trigger generation signal when an electrical signal input unit or a trigger button of a remote controller, for example, is operated. The trigger generator transmits the generated trigger generation signal to the trigger generation signal input unit by wire or wirelessly.

The trigger generator may be provided in the event time setting means 16. The trigger generator may be provided as a device separate from the event time setting means 16.

The trigger generation signal is inputted to the trigger generation signal input unit, to generate an event time such as a current time at which the trigger generation signal is inputted by the event time generation means.

If the event time setting means 16 is a device separate from the cameras 1, the timer may be synchronized with a time of the time signal transmission device 13 or each of the cameras 1 wirelessly or by wire.

If the event time setting means 16 is a member separate from the cameras 1, the event time setting means 16 may be provided with a similar device to the current time generation means 17 provided in each of the cameras 1 to generate a current time.

### Description of Event Time Reception Means 19

Then, for example, an event time generated by the event time setting means 16 is transmitted (A) to each of the cameras 1 by event time transmission means in, for example, a communication format based on a TCP/IP protocol such as a wireless communication format, and is received (A) by the event time reception means 19 in each of the cameras 1, as illustrated in FIGS. 1 and 3.

In the drawings, “A” indicates communication of an event time.

FIG. 3 illustrates an example in which a separate device 22 composed of, for example, a tablet, which differs from each of the cameras 1, is provided with the event time setting means 16.

In this example, the device 22 that has received the trigger generation signal from the trigger generator generates the event time by the event time setting means 16. The generated event time is transmitted (A) to each of the cameras 1. The event time reception means 19 in each of the cameras 1 receives (A) the event time.

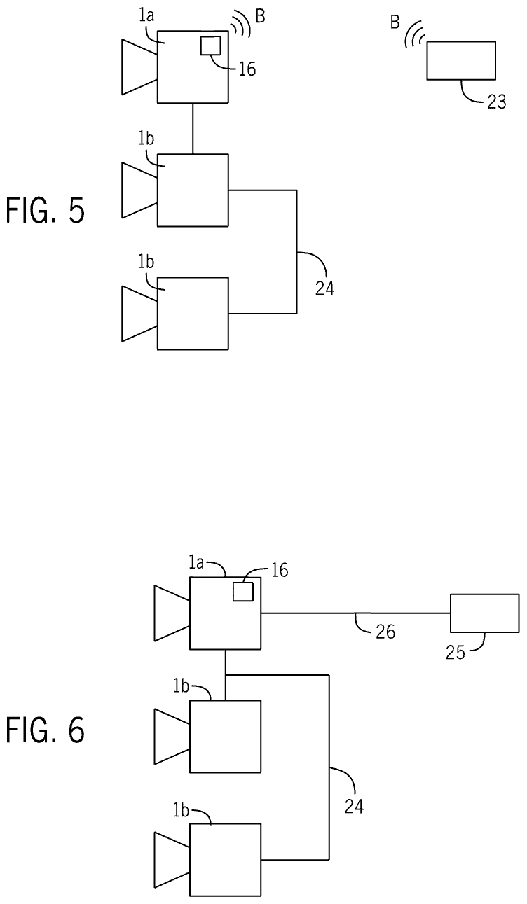

FIG. 5 illustrates another method for transmitting an event time to each of cameras. In FIG. 5, time synchronization means is omitted.

FIG. 5 illustrates an example in which the system control unit 7 in the one camera 1 (parent camera 1a) includes the event time setting means 16.

In this example, a trigger generator 23, for example, which generates a trigger generation signal using a control device such as a remote controller is operated, to generate the trigger generation signal. The trigger generation signal is transmitted (B) to the event time setting means 16 in the parent camera 1a by transmission means in a communication format based on a TCP/IP protocol provided in the trigger generator 23.

In the drawings, “B” indicates communication of a trigger generation signal.

The event time setting means 16 that has received (B) the trigger generation signal generates an event time. The event time generated by the event time setting means 16 may be notified to the event time reception means 19 (in this case, some of functions of the frame association means 20 may constitute the event time reception means 19) in the one camera 1 (parent camera 1a) and transmitted to the other cameras 1 (child cameras 1b) by wire 24 or wirelessly by the event time transmission means.

The wire 24 includes both an electrical signal cable and a communication cable. Examples of the communication cable include a network cable, a LAN cable, and a serial cable.

The event time setting means 16 may be provided in each of a plurality of cameras 1 other than the one camera 1a.

Instead of connecting the parent camera 1a and the trigger generator 23 to each other by the transmission means in the communication format based on the TCP/IP protocol, a trigger generator 25 that generates a trigger generation signal using an electrical signal input unit and the parent camera 1a may be connected to each other via an electrical signal cable 26 such as a BNC cable without an electronic device being interposed therebetween, as illustrated in FIG. 6.

In such a case, the time when the trigger generator 25 is operated and the time when the parent camera 1a receives the trigger generation signal can be synchronized with each other.

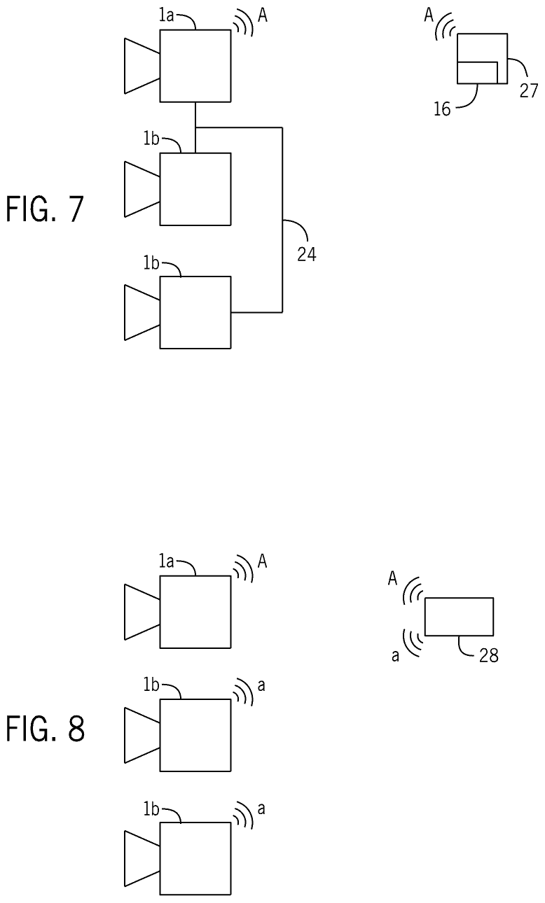

FIG. 7 illustrates still another method for transmitting an event time to each of cameras. In FIG. 7, time synchronization means is omitted.

Although an example illustrated in FIG. 6 is an example in which the parent camera 1a includes the event time setting means 16, the event time setting means 16 is provided in a device 27 separate from the parent camera 1a in an example illustrated in FIG. 7. The parent camera 1a may transmit an event time received (A) from the separate device 27 to the child camera 1b by wire 24 or wirelessly.

FIG. 8 illustrates still another method for transmitting an event time to each of cameras. In FIG. 8, time synchronization means is omitted.

As illustrated in FIG. 8, the one camera 1 (parent camera 1a) separately transmits (A) a received or generated event time to a device 28 such as a tablet by wire or wirelessly. The device 28 may transmit (a) the event time to event time reception means 19 in the other camera 1 (child camera 1b) by wire or wirelessly.

In the drawings, “a” indicates communication of an event time between the device 28 and the child camera 1b.

The child camera 1b that has received the event time from the parent camera 1a may transmit the event time to the other camera 1 (child camera 1b) by wire or wirelessly, similarly to the above, as a parent camera 1a.

The parent camera 1a or the child camera 1b and the other camera may be connected to each other via an electrical signal cable so that a trigger signal is notified therebetween.

The cameras and the like may be connected to each other by changing a combination in the above-described example.

A case where the event time setting means 16 is a device separate from each of high-speed cameras 1 in principle will be described below. However, the same applies to a case where the event time setting means 16 is provided in one or a plurality of cameras.

### Description of Trigger Time Generation Means 30 in Trigger Time Setting Means 29

The trigger time generation means 30 in the trigger time setting means 29 sets a time slightly later than a received event time, for example, as a trigger time. The trigger time is set to, for example, a final video recording time at the time when video recording is finished.

The time when video recording is finished is set from, for example, the event time.

### Description of Frame Association Means 20

The frame association means 20 in each of the cameras 1 determines whether or not a current time acquired from the current time generation means 17 has reached a trigger time set by the trigger time setting means 29, sets, when it is determined that the current time has reached the trigger time, an image frame in the case as an image frame at the trigger time (i.e., a trigger frame) and sets a predetermined image frame based on the image frame at the trigger time, and makes the predetermined image frames match one another in the cameras 1, thereby synchronizing the cameras 1 with one another.

### SPECIFIC EXAMPLE

Then, setting of a trigger time and an example of the frame association means will be described.

### Description of Corrected Trigger Time

In a case where the trigger time and image frames are made to match each other, when the trigger time is a boundary of each of the image frames (i.e., a start time or an end time of each of the image frames), the image frame can also be set as an image frame at the trigger time (hereinafter referred to as a “trigger frame”). However, when the trigger time and the start time or the end time of each of the image frames are shifted from each other due to an error in accuracy of the timer in each of the cameras 1 so that the image frame preceding or succeeding the image frame by one image frame may be recognized as a trigger frame. In this case, the respective image frames of the cameras 1 may be desynchronized with one another.

Therefore, in order to eliminate an influence of an error in time accuracy of each of the cameras 1, the trigger time setting unit 29 in the camera 1 is provided with a trigger time correction unit, for example. The trigger time correction unit may use a corrected trigger time set, as a trigger time, to a time later than a start time and earlier than an end time of an image frame, i.e., to be farther away from respective boundaries at a start time and an end time of the image frame.

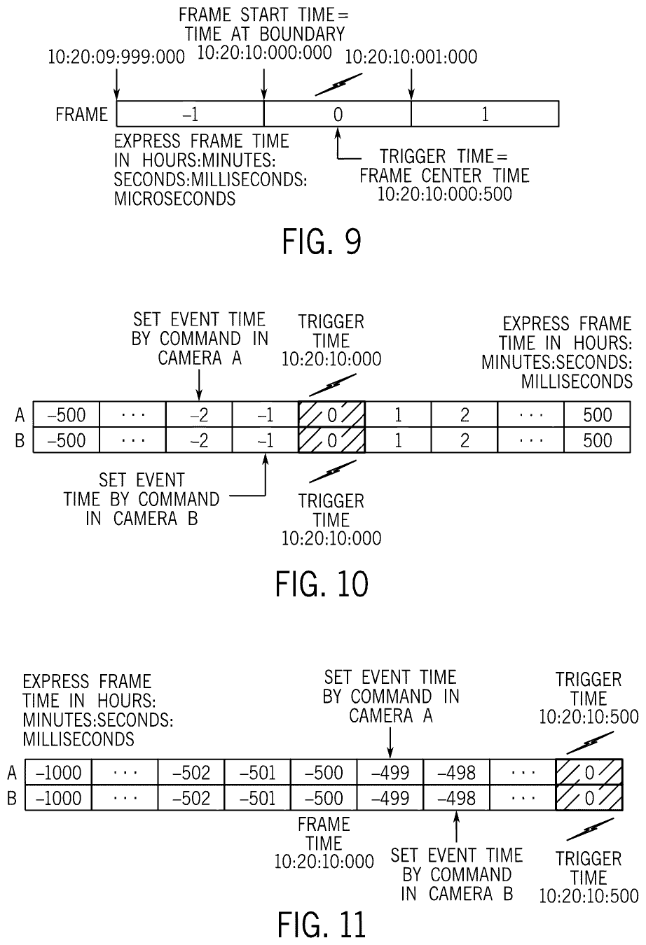

For example, when a start time of an image frame to be a trigger time is 10:20:10:000:000 (hours:minutes:seconds:milliseconds:microseconds) and an end time of the image frame is 10:20:10:001:000, as illustrated in FIG. 9, the trigger time is not set to 10:20:10:000:000 but set to an intermediate time 10:20:10:000:500 of the image frame.

The corrected trigger time as the intermediate time, for example, is thus used, thereby ensuring synchronization among the cameras 1.

If respective video recording speeds of the cameras 1 differ from one another and respective start times and end times of the trigger frames of the cameras 1 respectively differ from one another, as described below, the trigger time correction unit sets a corrected trigger time to be a time between the start time and the end time of the trigger frame of each of the cameras 1.

In the following description, a trigger time is a concept including a corrected trigger time.

### Trigger Time Setting Method 1

A method 1 is to perform setting for the trigger time generation means 30 for generating a trigger time in the trigger time setting means 29 in each of the cameras 1 to generate, when the cameras 1 receive the same event time from the event time setting means 16, the same trigger time as a time slightly later than the event time, for example, and to input a trigger signal to the video recording unit in the camera 1 when a current time of the camera 1 reaches the trigger time.

The above-described slightly later time is, for example, a time later by a time period corresponding to 10 image frames. If respective video recording speeds (one divided by cycles) of the cameras 1 differ from one another, the respective numbers of image frames until the slightly later times match one another in the cameras 1 differ from one another. Therefore, for example, a time later by a time period corresponding to 10 image frames in any one of the cameras 1 is set.

The frame association means 20 sets the image frame at the trigger time as a trigger frame, and makes the respective trigger frames of all the cameras 1 match one another.

That is, in this method 1, all the cameras 1 receive the event time from the event time setting means 16, and the trigger time setting means 29 in each of the cameras 1 sets, in consideration of a period elapsed until setting of the trigger time is completed, the trigger time to a time slightly later than the event time.

Thus, after all the cameras 1 receive the event time, a time of each of the cameras 1 can pass through the trigger time. Therefore, it is possible to make the respective trigger frames of the cameras 1 match one another.

FIG. 10 illustrates an example of the method 1 in two cameras (A and B) each operating at a video recording speed of 1000 fps, for example. The trigger time setting means 29 in each of the cameras receives the same event time as a command from outside. The trigger time setting means 29 in each of the cameras sets a trigger time (e.g., 10:20:10:000 (hours:minutes:seconds:milliseconds) as a time later than a current time at which the event time has been received (a corrected trigger time is 10:20:10:000:500 (hours:minutes:seconds:milliseconds:microseconds) that is an intermediate time of an image frame; the corrected trigger time is hereinafter omitted)).

The above-described command means instruction data used for camera control. The command may include trigger generation signal data. Further, the command may include event time data in order to transmit an event time. The command may also be included in communication based on a TCP/IP protocol.

The camera A receives the command as the event time at, for example, a time in an image frame (−2) before the trigger time, which will be set later. The camera B receives the command as the event time at a time in an image frame (−1) before the trigger time. That is, in the cameras A and B, the event times are respectively set by the commands. As a result, even if there is a difference in command reception time between the cameras A and B, the cameras 1 can be respectively set as trigger frames in time for the trigger time. Therefore, the respective trigger frames of the cameras A and B can be made to match each other.

Even if the trigger time is later than the current time, it is not ensured that the trigger time has been set in all the cameras. Therefore, the trigger frame may be shifted in the camera that has been too late to set the trigger time.

In the method 1, an image frame (event frame) at the event time and a trigger frame at a trigger time may be shifted by a small number of image frames.

### Trigger Time Setting Method 2

A method 2 is for trigger time generation means for generating a trigger time in the trigger time setting means 29 in each of the cameras 1 to calculate a time in an image frame at the end of video recording previously set in the camera 1 from a received event time (e.g., at the end of video recording previously set with the event time used as a reference) and set the calculated time as a trigger time, for example.

This method 2 is, for example, a case where a video recording time period (a cycle×the number of image frames) after an event frame is common among all the cameras 1. Here, a cycle (exposure timing) is set to one divided by a video recording speed. The number of image frames means the number of image frames from the event frame to an image frame at the end of video recording.

That is, the method 2 is, for example, a case where all the cameras 1 are the same in the video recording speed (or the exposure timing; the same applies hereinafter) and the number of image frames.

If all the cameras 1 are not the same in the video recording speed and are not the same in the number of image frames and are not the same in the video recording time period after the event frame, a method 3 described below is used.

In this method 2, the frame association means 20 sets the image frame at the trigger time as a predetermined image frame. Respective image frames at the end of video recording of all the cameras 1 match one another by making the predetermined image frames of the cameras 1 match each other.

That is, in this method 2, the trigger time is made to match not the event frame but the image frame at the end of video recording, to make the respective image frames of all the cameras 1 match one another.

In the method 2, for example, when the trigger time is reached in a video-recorded image frame number setting unit in the video recording unit 6, video recording in the memory 5 is stopped and a required number of image frames are video-recorded. For example, in an example of two cameras (A and B) each operating at a video recording speed of 1000 fps, as illustrated in FIG. 11, the number of image frames after triggering (excluding a trigger frame) is set to zero. The number of image frames before triggering is set to store only a required number of image frames (e.g., when 500 image frames and 500 image frames respectively preceding and succeeding an event frame are recorded, a total number of image frames, i.e., 1001 image frames including the event frame and the image frames and the image frames respectively preceding and succeeding the event frame).

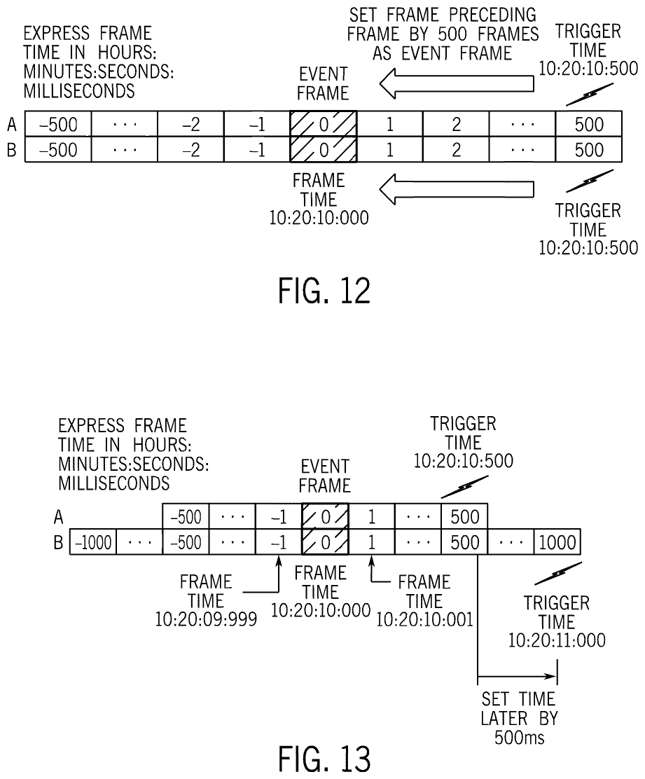

Further, for example, in an example of two cameras (A, B) each operating at a video recording speed of 1000 fps, as illustrated in FIG. 12, the frame association means 20 sets an image frame at the end of video recording as a trigger frame, as described above, for example, and then the image frame setting unit provided in the frame association means 20 calculates an event frame at an event time by further preceding the image frame at the end of video recording. The frame association means 20 may synchronize the cameras with each other by setting the event frame as a predetermined image frame and making the respective predetermined image frames of the cameras match each other.

The event frame at the event time is a concept also including an image frame at the time when an original trigger generation signal is inputted into the event time setting means 16 (see: [0094]).

As described above, the trigger time is set as an image frame at the end of video recording to synchronize the cameras with one another, thereby making it possible to maximize a period allowed until the setting of the trigger time in all the cameras is completed. Therefore, the number of cameras that are too late to set the trigger time can be reduced.

### Method 3 Using Frame Association Means

The method 2 assumes, when respective video recording time periods after event frames of the cameras 1 are the same, that image frames at the end of video recording are made to match each other, as described above. The method 2 is an example in which trigger times respectively set by the cameras 1 are the same.

However, a method 3 is a method assuming both a case where respective video recording time periods after event frames of the cameras 1 are the same and a case where they differ from one another. This method 3 is to perform setting, in the trigger time setting means 29 in each of the cameras 1, to calculate a time in an image frame at the end of video recording previously set for the camera 1 and generate the calculated trigger time for the camera 1 such that respective event frames at event times of the cameras 1 match each other. After the trigger time is set for each of the cameras 1, the image frame setting unit in the frame association means 20 in the camera 1 calculates the event frame from the image frame at the end of video recording. The respective calculated event frames of the cameras 1 are made to math one another, thereby synchronizing the cameras 1 with each other.

FIG. 13 illustrates, for example, a method for making respective event frames of the cameras match each other when the video recording speeds thereof are the same but the numbers of image frames thereof differ from each other. The method will be described below.

As illustrated in FIG. 13, in two cameras (A, B) each operating at a video recording speed of 1000 fps, the camera A can video-record 1001 image frames and can video-record an event frame and 500 image frames and 500 image frames respectively preceding and succeeding the event frame, and the camera B can video-record 2001 image frames and can video-record an event frame and 1000 image frames and 1000 image frames respectively preceding and succeeding the event frame. In the camera B, a time later by 500 milliseconds than that in the camera A is set as a trigger time. After an image frame at the end of video recording is set as a trigger frame, the image frame setting unit sets the image frame preceding the image frame at the end of video recording by 500 image frames as an event frame in the camera A and sets the image frame preceding the image frame at the end of video recording by 1000 image frames as an event frame in the camera B. Respective timings of the event frames are set to match each other in both the cameras A and B, thereby synthesizing the cameras A and B with each other.

In the method 3, the respective event frames of the cameras can be synchronized with each other even if the respective numbers of image frames of the cameras differ from each other.

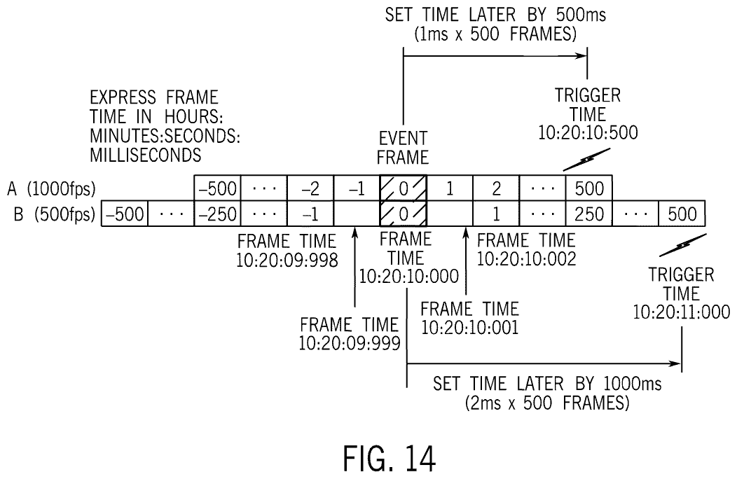

FIG. 14 illustrates a method for making respective event frames of the cameras match each other when the respective numbers of image frames of the cameras are the same but the respective video recording speeds thereof differ from each other. The method will be described below.

As illustrated in FIG. 14, there are two cameras (A and B), i.e., a camera A operating at a video recording speed of 1000 fps and a camera B operating at a video recording speed of 500 fps. The camera A and the camera B can each video-record 1001 image frames. The camera A and the camera B can each video-record an event frame and 500 image frames and 500 image frames respectively preceding and succeeding the event frame.

Since an image frame at the end of video recording in the camera A is later by 500 milliseconds (1 ms×500 image frames) than the event frame, a time later by 500 milliseconds than a time in the event frame is set as a trigger time in the camera A. Since an image frame at the end of video recording in the camera B is later by 1000 milliseconds (2 ms33 500 image frames) than the event frame, a time later by 1000 milliseconds than a time in the event frame is set as a trigger time in the camera B. After the image frame at the end of video recording of each of the cameras A and B is set as a trigger frame, the image frame setting unit sets the image frame preceding the trigger frame by 500 image frames as an event frame in the camera. Respective timings of the event frames are set to match each other in both the cameras A and B, thereby synthesizing the cameras A and B with each other.

In cameras, if their respective video recording speeds differ from one another and start times and end times of their respective trigger frames respectively differ from one another, a corrected trigger time is set to a time between the start time and the end time of the trigger frame of each of the cameras.

For example, in cameras in which respective boundaries of their image frames are set to match an exposure start time and the image frames are synchronized with one another by making respective start times of the image frames match one another, if respective video recording speeds differ from one another and respective exposure time periods are the same, corrected trigger times are preferably set, when the video recording speeds of the cameras are in a relationship of integral multiples of one another, to a time slightly later than the start time of the image frame of the camera having the lowest video recording speed used as a reference.

A time period until the above-described slightly later time means a time period longer than zero and shorter than a time period from the start time to an end time of the image frame of the camera having the highest video recording speed. The time period is, for example, half of a time period from the start time to the end time of the image frame of the camera having the highest video recording speed.

For example, if there are three types of cameras respectively having video recording speeds of 500 fps, 1000 fps, and 2000 fps, a time later by half (250 microseconds) of a frame cycle of the camera having the highest video recording speed of 2000 fps than a start time of the camera having the recording speed of 500 fps (a cycle of 2 milliseconds) used as a reference may be set as a corrected trigger time.

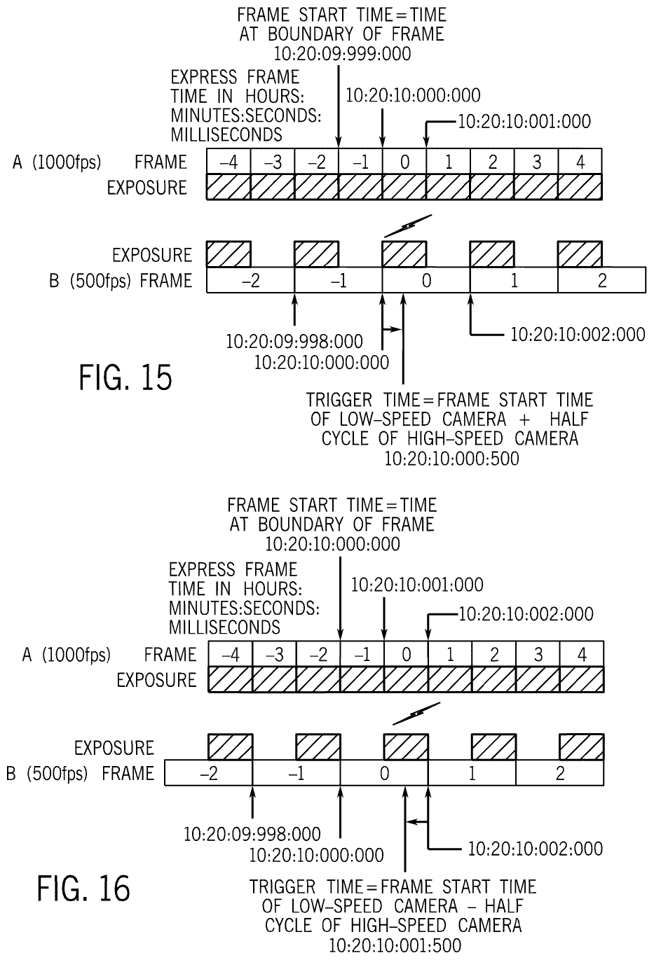

For example, consider a case where an exposure time period of each of the cameras is set to one millisecond, as illustrated in FIG. 15. In two cameras (A, B), i.e., a camera A operating at a video recording speed of 1000 fps and a camera B operating at a video recording speed of 500 fps, a corrected trigger time is set, with respective boundaries (10:20:09:998:000), (10:20:10:000:000), and (10:20:10:002:000) of image frames of the camera B having the lower video recording speed used as a reference, to a time (10:20:10:000:500) obtained by adding only a half cycle of each of the image frames (10:20:09:999:000), (10:20:10:000:000), and (10:20:10:001: 000) of the camera A having the higher video recording speed to a time in the image frame succeeding the image frame at the time when a trigger signal is inputted (e.g., a start time (10:20:10:000:000) of the image frame to be an event frame) among the image frames. This makes it possible to set an image frame that is common among all the cameras as a trigger frame while eliminating an influence of an error in time accuracy of each of the cameras.

For example, consider a case where respective exposure times of cameras set such that boundaries of image frames respectively match an exposure end time and end times of the image frames are made to match each other so that the image frames are synchronized with each other are each set to one millisecond, as illustrated in FIG. 16. In two cameras (A, B), i.e., a camera A operating at a video recording speed of 1000 fps and a camera B operating at a video recording speed of 500 fps, a corrected trigger time is set, with respective boundaries (10:20:09:998:000), (10:20:10:000:000), and (10:20:10:002:000) of image frames of the camera B having the lower video recording speed used as a reference, to a time (10:20:10:000:500) obtained by subtracting only a half cycle of each of the image frames (10:20:09:999:000), (10:20:10:000:000), and (10:20:10:001:000) of the camera A having the higher video recording speed from a time in the image frame preceding the image frame at the time when a trigger signal is inputted (e.g., an end time (10:20:10:000:000) of the image frame to be an event frame) among the image frames. This makes it possible to set an image frame that is common among all the cameras as a trigger frame while eliminating an influence of an error in time accuracy of each of the cameras.

### Comparison Between Conventional Method and Method According to Invention

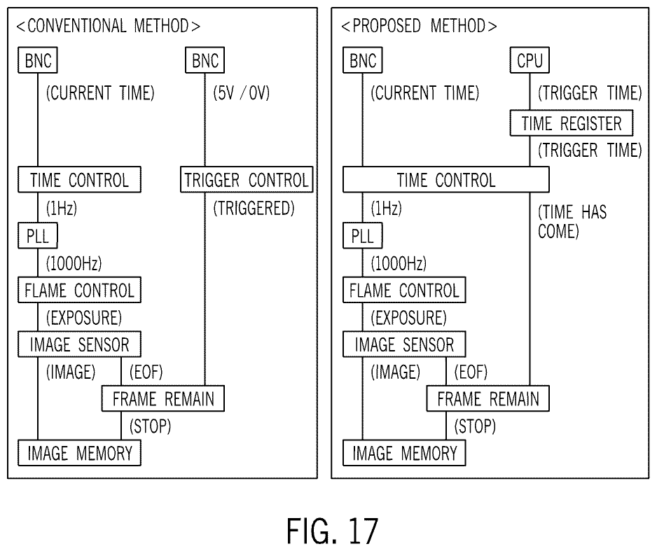

FIG. 17 illustrates and describes a comparison between respective flows of a conventional method and a new method.

As illustrated in FIG. 17, in the conventional method and the new method, respective methods for controlling exposure timings by time signals are the same.

That is, a current time signal is inputted from a BNC connector. A 1 Hz signal is generated by a time control unit in the current time generation means 17. A signal (hereinafter referred to as a VD signal; e.g., 1000 Hz in FIG. 2) obtained by equally dividing the generated 1 Hz signal into frequencies of video recording speeds is generated by the phase locked loop (PLL) in the exposure signal generation means 18.

An exposure start signal generated by a frame control unit in the exposure signal generation means 18 from the VD signal is inputted into an image sensor (the imager unit 4). Accordingly, video recording is performed at a predetermined exposure timing, and image data is read out from the image sensor and is recorded in an image memory unit (the video recording memory 5) in a ring buffer shape.

Image frames to be recorded are managed such that the video recording is stopped when a trigger time is inputted into a frame remain unit (the video recording unit 6) and the specified numbers of image frames respectively preceding and succeeding a trigger frame are recorded.

The conventional method and the new method differ in a method for generating a trigger time to be inputted into the frame remain unit (video recording unit 6).

In the conventional method, a trigger signal is inputted from the BNC connector via an electrical signal cable, the trigger signal is inputted into a trigger control unit, and the trigger signal is inputted into the frame remain unit (video recording unit 6). With this time used as a reference, recording into the video recording memory is stopped under predetermined conditions.

In the new method, in a CPU unit in each of the cameras, a trigger time is regenerated such that respective event frames of a plurality of cameras are the same by a time register unit on the basis of an inputted event time.

In each of the cameras, when the trigger time is inputted into the time control unit, a trigger signal is generated when the trigger time is reached, and the trigger signal is inputted into the frame remain unit (video recording unit 6) so that respective trigger frames of the cameras can be synchronized with one another. Accordingly, this eliminates the need to input the trigger signal by the BNC connector.

### SECOND EMBODIMENT

### Description of Overall Configuration of Second Embodiment

A second embodiment will be described below. Units not particularly described are the same as those in the first embodiment, and descriptions thereof are omitted.

In the second embodiment of the present invention, the trigger information for generating the trigger signal in the video recording unit in the first embodiment is a trigger sequence number. The trigger information setting means is composed of trigger sequence number setting means. The camera synchronization means is composed of sequence number synchronization means.

The synchronization signal setting means for setting (generating) the synchronization signal and transmitting the synchronization signal to each of the required high-speed cameras 1 is composed of sequence number matching time setting means and event time sequence number information setting means.

The sequence number matching time setting means is configured to set (generate) a sequence number matching time at which a sequence number sequentially set and assigned to each of video-recorded image frames is set to a predetermined number in each of the high-speed cameras 1 and transmit the sequence number matching time to each of the required high-speed cameras 1.

The event time sequence number information setting means is configured to set (generate) event time sequence number information such as a sequence number at an event time for setting a trigger sequence number in the trigger sequence number setting means and transmit the event time sequence number information to each of the required high-speed cameras 1.

Examples of the event time sequence number information include a predetermined sequence number corresponding to the event time in addition to the sequence number at the event time.

The trigger sequence number setting means is configured to generate, a trigger sequence number, which corresponds to an image frame for transmitting a trigger signal to a video recording unit on the basis of the received event time sequence number information.

That is, in the second embodiment of the present invention, respective time axes of timers of the high-speed cameras 1 are first synchronized with one another, and respective time axes of the cameras 1 are aligned with one another. The high-speed cameras 1 respectively perform exposures at predetermined exposure timings (cycles) to match the time axes, thereby synchronizing respective image frames of the cameras 1 with one another. In each of the high-speed cameras 1, a sequence number setting unit described below sequentially numbers the image frames recorded in a video recording memory in order. The sequence number matching time setting means transmits the same sequence number matching time to the high-speed cameras 1. Each of the high-speed cameras 1 makes, when the sequence number matching time is reached, the sequence number of the image frame of the high-speed camera 1 match the set predetermined number. As a result, the respective sequence numbers of the high-speed cameras 1 match one another. Then, the event time sequence number information setting means transmits the same event time sequence number information to the high-speed camera 1. The trigger sequence number setting means in each of the high-speed cameras 1 that has received the same event time sequence number information generates a trigger sequence number for transmitting a trigger signal to a video recording unit in the high-speed camera 1 on the basis of the received event time sequence number information. When the sequence number of each of the high-speed cameras 1 reaches the generated trigger sequence number, the trigger signal is transmitted to the video recording unit in the high-speed camera 1. As a result, the respective image frames of the high-speed cameras 1 are synchronized with one another.

Matching the above-described set predetermined number may include changing the sequence number of each of the high-speed cameras 1 to the same number as a specific number such as zero.

Matching the above-described set predetermined number may be considered as matching the set predetermined number with respective different sequence numbers of the high-speed cameras 1 when the sequence number matching time is reached used as a reference.

There are various patterns such as a case where the sequence number matching time setting means and the event time sequence number information setting means are respectively provided in different devices, a case where they are provided in the same device, and a case where they are provided in each of the high-speed cameras 1.

### Description of Sequence Number Synchronization Means

The sequence number synchronization means includes a sequence number setting unit that sequentially numbers an image frame recorded in a video recording memory in order in a ring buffer shape at a set predetermined exposure timing, current time generation means 17 for synchronizing a timer of the system control unit 7 with a current time signal (time code) transmitted at a regular low-resolution timing from outside a time signal transmission device 13 or the like other than each of the high-speed cameras 1, further dividing a predetermined time period at equal intervals on the basis of the current time signal, and generating a high-resolution current time, exposure signal generation means 18 for generating an exposure signal for imaging an image according to an exposure timing set on the basis of the current time obtained by the division at the equal intervals by the current time generation means 17, sequence number matching time reception means for receiving a sequence number matching time, event time sequence number information reception means for receiving event time sequence number information from the event time sequence number information setting means, and frame association means 20 for making the respective sequence numbers of the high-speed cameras 1 match one another from the sequence number matching time received by the sequence number matching time reception means and associating a trigger sequence number generated in the trigger sequence number setting means with a predetermined image frame imaged and video-recorded under an exposure by the exposure signal generation means 18.

The frame association means 20 first determines whether or not the current time generated by the current time generation means 17 has reached the sequence number matching time acquired from the sequence number matching time reception means, and sets, when it is determined that the current time has reached the sequence number matching time, the sequence number of each of the high-speed cameras 1 to a predetermined value, for example, and sets the sequence number to zero (resets the sequence number) using a sequence number matching unit such as a reset unit that resets the sequence number, to make the respective sequence numbers of the high-speed cameras 1 match one another. The frame association means 20 sets, when the sequence number of each of the high-speed cameras 1 reaches the trigger sequence number generated by the trigger sequence number setting means, an image frame in the case as an image frame in the trigger sequence number, transmits a trigger signal to the video recording unit 6, and makes the respective image frames in the trigger sequence numbers match one another in the high-speed cameras 1, thereby synchronizing the high-speed cameras 1 with one another.

When the respective sequence numbers of the high-speed cameras 1 are considered to match one another with the different sequence numbers of the high-speed cameras 1 at the time when the sequence number matching time is reached used as a reference, each of the high-speed cameras 1 stores the sequence number of the high-speed camera 1 instead of resetting the sequence number to a specific number such as zero when the sequence number matching time is reached. It may be determined whether or not a difference between the sequence number of each of the high-speed cameras 1 and the stored sequence number has reached a trigger sequence number.

The sequence number matching time setting means and the event time sequence number information setting means each have the same configuration and function as those of the event time setting means 16 in the first embodiment. The sequence number matching time setting means and the event time sequence number information setting means are connected to, for example, each of the cameras 1 by wire or wirelessly, like in the first embodiment.

The sequence number matching time reception means and the event time sequence number information reception means each have the same configuration and function as those of the event time reception means 19 in the first embodiment. The sequence number matching time reception means and the event time sequence number information reception means are connected to, for example, each of the cameras 1 by wire or wirelessly, like in the first embodiment.

If respective exposure timings (or video recording speeds) of the cameras 1 differ from one another, the respective sequence numbers at the same time of the cameras 1 are shifted from one another. Therefore, the cameras 1 are respectively provided with sequence number correction units that consider the sequence numbers at the same time as the same sequence number. The sequence number correction units respectively correct the sequence numbers at the same time in the cameras 1 as being the same, thereby synchronizing the cameras 1 with one another.

In the cameras respectively having different video recording speeds, for example, the sequence number correction units respectively set the sequence numbers assigned to the cameras to be the same number at the same time.

That is, if there are two types of cameras respectively having video recording speeds of 1000 fps and 500 fps, for example, the sequence number correction units perform such setting, respectively, to add one to a sequence number, e.g., [00], [01], [02], and [03] in the camera having the video recording speed of 1000 fps (the shorter cycle) and to add two to a sequence number, e.g., [00], [02], [04], and [06] in the camera having the video recording speed of 500 fps (twice the shorter cycle). As a result, in the cameras, it is determined whether or not the same predetermined trigger sequence number has been reached.

The cameras may be synchronized with each other without actually correcting the sequence numbers but considering the sequence numbers to have been corrected.

As another method, the sequence number correction unit performs setting to correct a trigger sequence number for each of the cameras such that trigger signals are respectively generated at the same time in the cameras.

That is, in a case where there are two types of cameras respectively having video recording speeds of 1000 fps and 500 fps, for example, one is added to a sequence number, e.g., [00], [01], [02], and [03] in both the cameras. The sequence number correction units perform such setting that when a trigger sequence number is <17> in the camera having the video recording speed of 1000 fps (the shorter cycle), it is <34> as a double value in the camera having the video recording speed of 500 fps (twice the shorter cycle). It is determined whether or not the sequence number has reached <17> in the camera having the video recording speed of 1000 fps, and it is determined whether or not the sequence number has reached <34> in the camera having the video recording speed of 500 fps.

### Specific Description of Frame Association Means

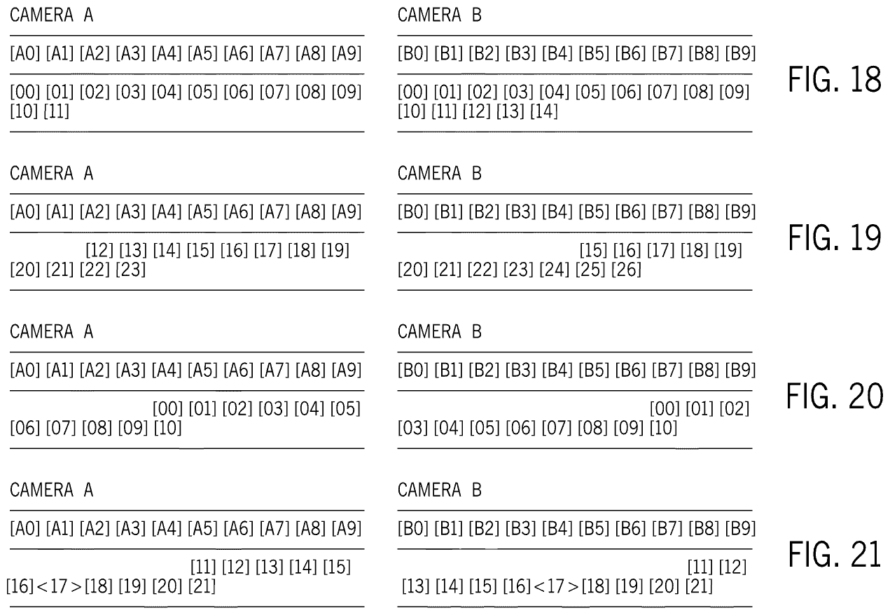

For example, video recording is started in such setting that image frames [A0] to [A9] on a physical region of a video recording memory of a camera A are written in a ring buffer shape and image frames [B0] to [B9] on a physical region of a video recording memory of a camera B are written in a ring buffer shape, as illustrated in FIG. 18. Imaged image frames are sequentially written into each of the video recording memories. The imaged image frames are respectively assigned sequence numbers [00], [01], [02], . . . to correspond to the sequentially video-recorded image frames by the sequence number setting unit.

Assuming that times have already been synchronized with each other, FIG. 18 illustrates how the newest sequence numbers at the same time have not matched each other yet in the camera A and the camera B. That is, the respective new sequence numbers in the camera A and the camera B are [11] and [14], that is, are shifted by three image frames.

Here, the sequence number matching time setting means, for example, transmits an instruction (command) to indicate a sequence number matching time “10:20:10:000:500” such as a reset time at which a sequence number is reset to all high-speed cameras via Wi-Fi or the like. Accordingly, when the time (10:20:10:000:500) is reached in each of the high-speed cameras, if the newest sequence number is [23] in the camera A and is [26] in the camera B, for example, as illustrated in FIG. 19, respective subsequent sequence numbers are each returned to [00] (reset) in the camera A and the camera B, as illustrated in FIG. 20. Sequence numbers are each sequentially assigned from [00]. As a result, the respective sequence numbers in the camera A and the camera B match each other so that video recording is continued.

Then, the event time sequence number information setting means transmits an event time, for example, to all the high-speed cameras via Wi-Fi or the like. The trigger sequence number setting means in each of the cameras, which have received the event time, calculates a sequence number at the event time, for example, and sets a sequence number slightly later than the sequence number, e.g., a sequence number [17]. As a result, when a sequence number of an image frame of each of the high-speed cameras is 17, as illustrated in FIG. 21, a trigger signal is transmitted. As a result, video recording is stopped in a predetermined image frame, and required numbers of image frames (e.g., sequence numbers [12] to [21]) preceding and succeeding the image frame corresponding to the sequence number set by the video-recorded image frame number setting unit are left.

Although the sequence number slightly later than the sequence number at the event time is set in the above-described example, a sequence number at the end of video recording may be set, like in the first embodiment.

An event time sequence number corresponding to an event time may be set and transmitted to each of the cameras by the event time sequence number information setting means. The trigger sequence number setting means in each of the cameras may set a sequence number slightly later than the event time sequence number as a trigger sequence number, or may set a sequence number at the end of video recording as a trigger sequence number.

What is claimed is:

1. A synchronous camera apparatus comprising a plurality of high-speed cameras, the synchronous camera apparatus comprising:
a plurality of high-speed cameras each including an imager unit that images a target video image by sequentially performing an exposure at a set exposure timing, a video recording memory, a video recording unit that video-records a predetermined image imaged by the imager unit as an image frame of digital data in the video recording memory by input of a trigger signal, and a system control unit that has a timer and performs various types of calculations; and
synchronization signal setting means for setting a synchronization signal and transmitting the set synchronization signal to each of the high-speed cameras, wherein
the system control unit in each of the high-speed cameras includes trigger information setting means for setting trigger information for generating a trigger signal to the video recording unit from the received synchronization signal and camera synchronization means, and
the camera synchronization means includes
current time generation means for synchronizing, on the basis of a current time signal transmitted at a regular timing from outside, the timer with the current time signal to generate a current time and determining the exposure timing on the basis of the current time, and
frame association means for associating, when it is determined that the current time acquired from the current time generation means has reached the trigger information set by the trigger information setting means, the trigger information with the image frame in the case.

2. The synchronous camera apparatus comprising the plurality of high-speed cameras according to claim 1, wherein
the synchronization signal setting means for setting the synchronization signal and transmitting the set synchronization signal to each of the high-speed cameras is event time setting means for setting an event time and transmitting the set event time to each of the high-speed cameras,
the trigger information setting means for setting trigger information for generating a trigger signal to the video recording unit from the received synchronization signal is trigger time setting means for setting a trigger time for generating a trigger signal to the video recording unit from the received event time,
the camera synchronization means is trigger frame synchronization means, and
the frame association means for associating, when it is determined that the current time acquired from the current time generation means has reached the trigger information set by the trigger information setting means, the trigger information with the image frame in the case is means for associating, when it is determined that the current time acquired from the current time generation means has reached the trigger time received by the trigger time setting means, the trigger time with the image frame in the case.

3. The synchronous camera apparatus comprising the plurality of high-speed cameras according to claim 2, wherein
the frame association means in each of the high-speed cameras is means for determining whether or not the current time of the image frame has reached the trigger time, setting, when it is determined that the current time has reached the trigger time, the image frame as an image frame at the trigger time, transmitting the trigger signal to the video recording unit and setting a predetermined image frame based on the image frame, and making the respective predetermined image frames match one another in the high-speed cameras, thereby synchronizing the high-speed cameras with one another.

4. The synchronous camera apparatus comprising the plurality of high-speed cameras according to claim 3, wherein
making the respective predetermined image frames based on the image frames match one another in the high-speed cameras, to synchronize the high-speed cameras with one another means making the respective image frames at the trigger times of the high-speed cameras match one another as predetermined image frames.

5. The synchronous camera apparatus comprising the plurality of high-speed cameras according to claim 3, wherein
making the respective predetermined image frames based on the image frames match one another in the high-speed cameras, to synchronize the high-speed cameras with one another means providing the frame association means in each of the high-speed cameras with an image frame setting unit that sets an image frame having a predetermined relationship from the image frame at the trigger time of the high-speed camera, to make the predetermined image frames respectively set by the image frame setting units in the high-speed cameras match one another.

6. The synchronous camera apparatus comprising the plurality of high-speed cameras according to claim 3, wherein the predetermined image frame is an event frame of an image frame at a time when an event time is inputted into each of the high-speed cameras.

7. The synchronous camera apparatus comprising the plurality of high-speed cameras according to claim 2, wherein the trigger time is set to a time later than a time when the trigger time setting means receives an event time.

8. The synchronous camera apparatus comprising the plurality of high-speed cameras according to claim 2, wherein the trigger time is set to a time of an image frame at a time when video recording is finished.

9. The synchronous camera apparatus comprising the plurality of high-speed cameras according to claim 2, wherein
the trigger time is set to a time of an image frame at a time when video recording is finished, and
an image frame setting unit provided in the frame association means in each of the high-speed cameras calculates an event frame as an image frame at a time when an event time is inputted from an image frame at the trigger time, and makes the respective event frames match one another in the high-speed cameras, thereby synchronizing the high-speed cameras with one another.

10. The synchronous camera apparatus comprising the plurality of high-speed cameras according to claim 2, wherein the trigger times respectively inputted into the high-speed cameras match one another.

11. The synchronous camera apparatus comprising the plurality of high-speed cameras according to claim 2, wherein the trigger time of each of the high-speed cameras is set to correspond to an exposure timing set for the high-speed camera or/and a number of image frames, respective video records of which are left in a video recording memory.

12. The synchronous camera apparatus comprising the plurality of high-speed cameras according to claim 2, wherein the trigger time is set to a time later than a start time and earlier than an end time of the image frame, in which the trigger time is set, of each of the high-speed cameras.

13. The synchronous camera apparatus comprising the plurality of high-speed cameras according to claim 12, wherein in the high-speed cameras, respective set video recording speeds of which differ from one another and respective image frames of which are synchronized with one another by making start times of the image frames match one another, the trigger time is further set to be a time obtained by adding a time period longer than zero and shorter than a cycle (one divided by the video recording speed) of the high-speed camera having the highest video recording speed to the start time of the image frame of the high-speed camera having the lowest video recording speed in which the trigger time is set.

14. The synchronous camera apparatus comprising the plurality of high-speed cameras according to claim 12, wherein in the high-speed cameras, respective set video recording speeds of which differ from one another and respective image frames of which are synchronized with one another by making end times of the image frames match one another, the trigger time is further set to be a time obtained by subtracting a time period longer than zero and shorter than a cycle (one divided by the video recording speed) of the high-speed camera having the highest video recording speed from the end time of the image frame of the high-speed camera having the lowest video recording speed in which the trigger time is set.

15. The synchronous camera apparatus comprising the plurality of high-speed cameras according to claim 1, wherein the current time signals are respectively acquired from wireless time synchronization devices respectively connected to the high-speed cameras via electrical signal cables without electronic devices being interposed thereamong and configured to be wirelessly synchronized with one another.

16. The synchronous camera apparatus comprising the plurality of high-speed cameras according to claim 2, wherein
the event time setting means is provided in at least one of the plurality of high-speed cameras, and
the event time generated by the event time setting means is notified to the at least one high-speed camera and is transmitted to the other high-speed cameras.

17. The synchronous camera apparatus comprising the plurality of high-speed cameras according to claim 16, wherein
the event time generated by the event time setting means is generated on the basis of a trigger generation signal inputted into the at least one high-speed camera.

18. The synchronous camera apparatus comprising the plurality of high-speed cameras according to claim 1, wherein
the system control unit in each of the high-speed cameras includes a sequence number setting unit that sequentially numbers an image frame recorded in the video recording memory in order at a set predetermined exposure timing,
the synchronization signal setting means for setting the synchronization signal and transmitting the set synchronization signal to each of the high-speed cameras includes
sequence number matching time setting means for setting (generating) a sequence number matching time for setting a sequence number of each of the high-speed cameras to a predetermined number and transmitting the sequence number matching time to each of the required high-speed cameras, and
event time sequence number information setting means for setting event time sequence number information and transmitting the set event time sequence number information to each of the high-speed cameras,
the trigger information setting means for setting the trigger information for generating the trigger signal to the video recording unit from the received synchronization signal includes
means for making respective sequence numbers of the high-speed cameras match one another from the received sequence number matching times, and
trigger sequence number setting means for setting a trigger sequence number for generating the trigger signal to the video recording unit from the received event time sequence number information,
the camera synchronization means is sequence number synchronization means, and
the frame association means for associating, when it is determined that the current time acquired from the current time generation means has reached the trigger information set by the trigger information setting means, the trigger information with the image frame in the case is frame association means for setting, when it is determined that the current time generated by the current time generation means has reached the received sequence number matching time, the sequence number of each of the high-speed cameras to a predetermined value using a sequence number matching unit to make the sequence numbers of the high-speed cameras match one another, and associating, when it is determined that the sequence number of each of the high-speed cameras has reached the trigger sequence number, the trigger sequence number with the image frame in the case.

19. The synchronous camera apparatus comprising the plurality of high-speed cameras according to claim 18, wherein
the frame association means in each of the high-speed cameras is means for determining whether or not the current time generated by the current time generation means has reached the received sequence number matching time, setting, when it is determined that the current time has reached the sequence number matching time, the sequence number of each of the high-speed cameras to a predetermined value using the sequence number matching unit to make the sequence numbers of the high-speed cameras match one another, setting, when the sequence number of each of the high-speed cameras reaches the trigger sequence number, the image frame in the case as an image frame in the trigger sequence number, transmitting the trigger signal to the video recording unit, and making the image frames in the trigger sequence numbers of the high-speed cameras match one another, thereby synchronizing the high-speed cameras with one another.

20. The synchronous camera apparatus comprising the plurality of high-speed cameras according to claim 18, wherein
when the respective exposure timings of the high-speed cameras differ from one another, the high-speed cameras are respectively provided with sequence number correction units that correct the sequence numbers of the high-speed cameras to be the same at the same time.
